(19) United States
(12) Patent Application Publication
(10) Pub. No.: US 2025/0272416 A1
(43) Pub. Date: Aug. 28, 2025

(54) METHOD AND DEVICE FOR ENCRYPTING DATA

(71) Applicant: Samsung Electronics Co., Ltd., Suwon-si (KR)

(72) Inventor: Soyoung LEE, Suwon-si (KR)

(21) Appl. No.: 19/208,312

(22) Filed: May 14, 2025

Related U.S. Application Data
(63) Continuation of application No. PCT/KR2023/017257, filed on Nov. 1, 2023.

(30) Foreign Application Priority Data
Nov. 29, 2022 (KR) 10-2022-0163173

(51) Int. Cl. G06F 21/60; G06F 11/14; G06F 21/78

(52) U.S. Cl. CPC G06F 21/602; G06F 11/1451; G06F 21/78

(57) ABSTRACT

Disclosed are a method for a user device to encrypt data and the user device. The method according may comprise: acquiring a first seed from an external device; generating a second seed in response to acquiring the first seed; generating a first encryption key based on the first seed and the second seed; and encrypting data using the first encryption key.

### CROSS-REFERENCE TO RELATED APPLICATIONS

This application is a continuation of International Application No. PCT/KR2023/017257 designating the United States, filed on Nov. 1, 2023, in the Korean Intellectual Property Receiving Office and claiming priority to Korean Patent Application No. 10-2022-0163173, filed on Nov. 29, 2022, in the Korean Intellectual Property Office, the disclosures of each of which are incorporated by reference herein in their entireties.

### BACKGROUND

### Field

The disclosure relates to a method and device for encrypting data.

### Description of Related Art

A variety of security methods have been proposed and used to manage important documents or data. For example, with the development of electronic technology, the security technology is increasingly required as large amount of data can now be stored in a small-sized device. As the importance of security technology increases, various methods of security processing are emerging.

### SUMMARY

Embodiments of the disclosure provide an encryption method and a device for preventing and/or reducing or suppressing data from being exposed to danger due to hacking of a server.

An example embodiment of the disclosure relates to a method for encrypting data by a user device. The method according to an example embodiment may include: obtaining a first seed from an external device, generating a second seed in response to obtaining the first seed, generating a first encryption key based on the first seed and the second seed, and encrypting data using the first encryption key.

According to an example embodiment, the obtaining the first seed from the external device may include requesting transmission of the first seed to the external device, and receiving the first seed from the external device in response to the request.

According an example embodiment, the requesting the transmission of the first seed may be triggered based on detecting a backup event.

According to an example embodiment, the backup event may may be detected based on receiving an input requesting data backup or preset reservation information.

According to an example embodiment, the encryption may include: in response to detection of the backup event in a first encryption mode that encrypts the data using the first encryption key, encrypting the data using the first encryption key, and transmitting the encrypted data to the external device.

According to an example embodiment, the method may further include: transmitting the data to the external device so that the external device encrypts the data using the second encryption key, in response to detection of the backup event in a second encryption mode that encrypts the data using a second encryption key different from the first encryption key.

According to an example embodiment, the first seed and the second seed may include a random number of at least 16 bytes or at least 32 bytes.

According to an example embodiment, the method may further include transmitting the encrypted data to the external device.

An example embodiment of the disclosure relates to a user device. The user device according to an example embodiment may include: at least one processor, comprising processing circuitry, memory, and one or more programs, the one or more programs stored in the memory, wherein at least one processor, individually and/or collectively, is configured to execute the instructions and to cause the user device to: obtain a first seed from an external device, generate a second seed in response to obtaining the first seed, generate a first encryption key based on the first seed and the second seed, and encrypt data using the first encryption key.

According to various example embodiments of the disclosure improves data security, since the data recorded in the server cannot be decrypted even though there is a hacking attempt onto a server end. Accordingly, the data on the user device backed up in the server end can be free from any external hacking attempts.

Effects that can be obtained from the disclosure are not limited to those mentioned above, and other effects not mentioned herein may be clearly understood by one skilled in the art to which the disclosure belongs from the following description. Any unintended effects of implementing example embodiments of the disclosure may also be derived by one skilled in the art from example embodiments of the disclosure.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example configuration of a first device and a second device according to various embodiments;

FIG. 2 is a block diagram illustrating an example data encryption process according to various embodiments;

FIG. 3 is a flowchart illustrating an example method for encrypting data by a user device according to various embodiments;

FIG. 4 is a flowchart illustrating an example method for decrypting data by a user device according to various embodiments;

FIG. 5 is a diagram illustrating an example blockchain system according to various embodiments;

FIGS. 6A and 6B are diagrams illustrating an example of a blockchain encryption technology according to various embodiments;

FIG. 7 is a diagram illustrating an example method for managing an encryption key using a blockchain system according to various embodiments; and

FIG. 8 is a diagram illustrating an example method for decrypting encrypted data using a blockchain system according to various embodiments.

Reference is made to the accompanying drawings in the following description, and certain examples that may be implemented are shown by way of illustration in the drawings. Further, other examples may be utilized and structural changes may be made without departing from the scope of the disclosure, including the various examples.

### DETAILED DESCRIPTION

Hereinafter, various example embodiments of the disclosure will be described in greater detail with reference to the drawings. However, the present disclosure may be implemented in a number of different forms and is not limited to the example embodiments described herein. With regard to the description of the drawings, the same or similar reference numerals may be used for the same or similar components. Further, in the drawings and their related descriptions, descriptions of well-known functions and configurations may be omitted for clarity and conciseness.

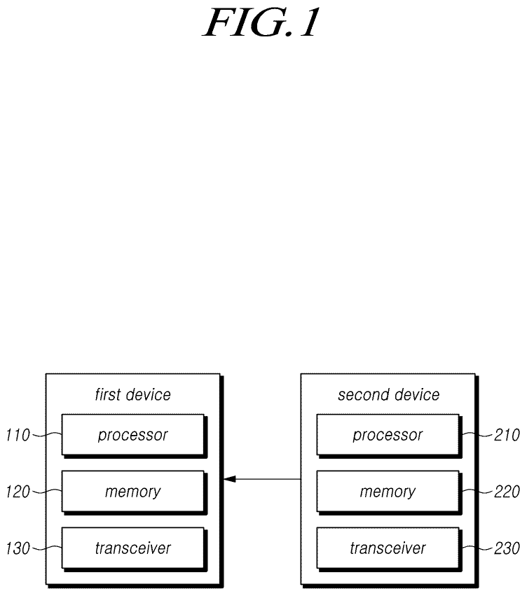

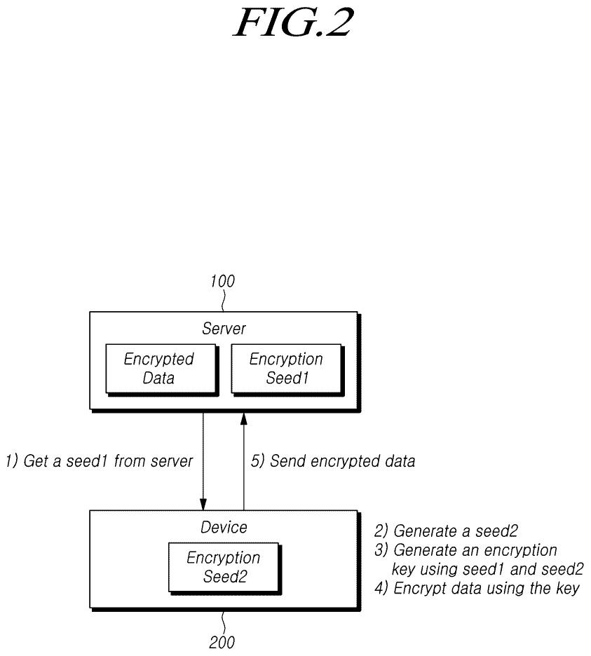

FIG. 1 is a block diagram illustrating an example configuration of a first device and a second device according to various embodiments. FIG. 2 is a block diagram illustrating an example data encryption process according to various embodiments.

Referring to FIGS. 1 and 2, the first device (e.g., user device) 100 and the second device (e.g., server) 200 may include at least partially the same components (e.g., processor, memory, transceiver, etc.). The first device 100 and the second device 200 may be connected by wire or wirelessly, and may transmit and receive data to and from each other while the connection is maintained. In various embodiments of the disclosure, the first device 100 may be understood as a user device and the second device 200 may be referred to as a server device. The term “user device” may be used interchangeably with “client device”, and “server device” may be used interchangeably with “cloud device”.

The devices (e.g., first device 100 and second device 200) according to various embodiments of the disclosure may include processors (e.g., including processing circuitry) 110 and 210, memories 120 and 220, and transceivers (e.g., including communication circuitry) 130 and 230, respectively. The memories 120 and 220, and the transceivers 130 and 230 may be electrically or functionally connected to the processors 110 and 210. The processors 110 and 210 may include various processing circuitry and generate and transmit a control command to control components of the devices 100 and 200.

According to various embodiments of the disclosure, the processors 110 and 210 may include storage and processing circuitry for supporting the operation of the devices 100 and 200. The storage and processing circuitry may include storage such as e.g., a nonvolatile memory (e.g., flash memory, or other electrically programmable ROM configured to form a solid state drive (SSD)), a volatile memory (e.g., static or dynamic RAM), or the like. The processing circuitry in the processors 110 and 210 may be used to control the overall operation of the devices 100 and 200. The processing circuitry may be configured based on one or more microprocessor(s), microcontroller(s), digital signal processor(s), baseband processor(s), power management section(s), audio chip(s), on-demand integrated circuit(s), or the like. The processor(s) 110 and 210 may each include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to various embodiments of the disclosure, the memories 120 and 220 may include memory areas for one or more processors 110 and 210 to store variables used in the protocol, configuration, control, and other functions of the devices 100 and 200, including operations corresponding to or including any of the methods and/or procedures described as an example. Further, the memories 120 and 220 may include a nonvolatile memory, a volatile memory, or a combination thereof. Furthermore, the memories 120 and 220 may interface with a memory slot that allows one or more formats of removable memory cards (e.g., SD card, memory stick, compact flash, etc.) to be inserted and removed.

According to various embodiments of the disclosure, the transceivers 130 and 230 may include various communication circuitry including, for example, a wireless communication module or an RF module. The wireless communication module may include, for example, Wi-Fi, BT, GPS, or NFC. For example, the wireless communication module may provide a wireless communication function using a radio frequency. The wireless communication module may include a network interface or a modem for connecting the devices 100 and 200 to a network (e.g., Internet, LAN, WAN, telecommunication network, cellular network, satellite network, POTS, or 5G network). The RF module may be responsible for transmitting and receiving data, for example, transmission and reception of an RF signal or an electronic signal invoked. For example, the RF module may include a power amplifier module (PAM), a frequency filter, or a low noise amplifier (LNA). Further, the RF module may further include components for transmitting and receiving electromagnetic waves on a free space in wireless communication, e.g., a conductor or a wire.

According to various embodiments of the disclosure, a program for performing a method of the disclosure may be executed. For example, the processor may execute instructions included in the program, and each of the instructions may correspond to one or more operations included in the encryption method of the disclosure. It may be understood that the following operations are performed by the processor 110 of the first device 100 and the processor 210 of the second device 200.

According to an embodiment, the first device 100 (e.g., a user device) may obtain a first seed from the second device 200 (e.g., a server). For example, the first device 100 may request the second device 200 to transmit the first seed. The first seed is generated by the second device 200 and may not be generated by the first device 100.

In an embodiment, requesting transmission of the first seed (e.g., encryption seed1) may be triggered based on detection of a backup event. The backup event may be detected, for example, based on an input (e.g., a user input) that generates the backup event. The backup event may be detected based on preset reservation information (e.g., a schedule in which the backup event is set to occur at a specific time).

In an embodiment, when the first device 100 obtains the first seed, the first device 100 may generate a second seed (e.g., an encryption seed2). For example, the first seed may be obtained from the second device 200 in response to a request of the first device 100. The second seed is a seed generated by the first device 100 and may not be generated by the second device 200. The first device 100 may store the first seed acquired from the second device 200 and the second seed directly generated in the memory.

The first seed and the second seed may include a random number for generating an encryption key (e.g., the first encryption key). The first encryption key may be generated using both the first seed and the second seed. Each of the first seed and the second seed may include a random number of 16 bytes or 32 bytes.

In an embodiment, the first device 100 may generate a first encryption key based on the first seed and the second seed. The first encryption key may be generated using both the first seed and the second seed. The generated first encryption key may be stored in the memory (e.g., storage) of the first device 100. The first encryption key is stored in the user device and is not shared with the second device 200.

In an embodiment, the first device 100 may encrypt data using the first encryption key. The encrypted data using the first encryption key may be stored in the memory of the first device 100. Further, data encrypted using the first encryption key may be transmitted to another device (e.g., the second device 200).

The second device 200 to which the encrypted data is to be transmitted may be determined as a device involved in generating the encryption key. The device involved in generating the encryption key may be referred to as a device that has transmitted the first seed to the first device 100. In an embodiment, the data encrypted by the first encryption key in the first device 100 may be transmitted to the second device 200 that provided the first seed. Alternatively, the encrypted data may not be transmitted to other devices that do not provide the first seed.

According to various embodiments of the disclosure, the user device may encrypt data by itself using the first encryption key, but the disclosure not limited thereto. For example, the user device may not only encrypt data using the first encryption key stored in the storage, but also encrypt data using a second encryption key stored in a storage of an external device (e.g., the second device 200). In other words, the first device 100 may selectively utilize either one of a first encryption method for encrypting data using the first encryption key or a second encryption method for encrypting data using the second encryption key. Hereinafter, an operation state for encrypting data based on the first encryption method may be defined as a first encryption mode, and an operation state for encrypting data based on the second encryption method may be defined as a second encryption mode.

In an embodiment, the user device may operate in either one of the first encryption mode or the second encryption mode. When a backup event is detected while the user device is operating in the first encryption mode, data may be encrypted using the first encryption key. When a backup event is detected while the user device is operating in the second encryption mode, data may be transmitted to an external device (e.g., any one of other devices including the second device 200) to be encrypted using the second encryption key.

The data encrypted using the first encryption key may be transmitted to the second device 200 and stored in the memory of the second device 200.

In the case of encryption using the second encryption key, the first device 100 may transmit data to the external device together with an encryption request. The data transmitted together with the request may be encrypted using the second encryption key stored in the storage of the external device. The data encrypted by the second encryption key may be stored in the storage of the external device.

In various embodiments of the disclosure, data encrypted by the first encryption key may not be decrypted by another encryption key. In other words, the data encrypted by the first device 100 cannot be decrypted by another device. When data is encrypted using the first encryption key and stored in an external other device, the encrypted data may not be leaked even if the other devices are hacked. However, when the user loses the first device 100 or the first device 100 is damaged, even the user may be unable to decrypt the encrypted data. The first device 100 being capable of operating in either one of the first encryption mode or the second encryption mode may encrypt data in either the first encryption method or the second encryption method according to a user's selection. In other words, according to various embodiments of the disclosure, for the first device 100 that is more likely to be lost or damaged, data may be encrypted in the second encryption method, and for the first device 100 that is less likely to be lost or damaged, data may be encrypted and backed up in an appropriate manner according to the purpose and use environment of the first device 100, such as encrypting data in the first encryption method.

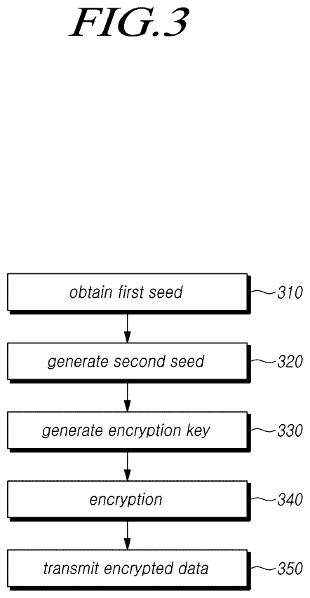

FIG. 3 is a flowchart illustrating an example method for encrypting data by a user device according to an embodiment.

Each operation of FIG. 3 may correspond to an instruction of a program stored in the memory (e.g., the memory 120 of FIG. 1) of the user device (e.g., the first device 100 of FIG. 1). The processor (e.g., the processor 110 of FIG. 1) of the user device may perform the following operation(s) by executing the instruction of the program.

In operation 310, the user device may obtain the first seed from an external device. The user device may, for example, request transmission of the first seed to the external device and receive a first seed in response to the request. Requesting transmission of the first seed may be triggered based on detection of a backup event. The backup event may be detected, for example, based on receiving a user input requesting backup or based on preset reservation information.

In operation 320, the user device may generate a second seed.

In operation 330, the user device may generate a first encryption key using the first seed and the second seed. The first seed and the second seed may include a random number of at least 16 bytes or at least 32 bytes.

The encryption key may be generated in various ways. For example, and without limitation, assuming that data is encrypted using AES 128, a 16-byte encryption key may be generated in the following manner. For example, in order to generate a 16-byte AES encryption key, a 16-byte first seed may be generated from an external device, a 16-byte second seed may be generated from a user device, and then a first encryption key may be generated by applying XOR to the first seed and the second seed. For example, in order to generate a 16-byte AES first encryption key, a 16-byte first seed may be generated from an external device, a 16-byte second seed may be generated using a user password input from the user device and a password-based key derivation function2, and then the first encryption key may be generated by applying XOR to the first seed and the second seed. For example, to generate the 16-byte AES encryption key, a 16-byte first seed may be generated from the external device, a 16-byte second seed may be generated from the user device, and then a first encryption key may be generated by AES encrypting the first seed with the second seed (or the first seed with the second seed).

In operation 340, the user device may encrypt data using the first encryption key. For example, data may be performed using the above-described advanced encryption standard (AES) method. The data is not limited thereto, but may include content data of the user device.

In operation 350, the user device may transmit encrypted data to the external device. The encrypted data may be transmitted to the external device that provided the first seed. In an embodiment, the user device may operate in either one of a first encryption mode for encrypting data using a first encryption key or a second encryption mode for encrypting data using a second encryption key different from the first encryption key. In an embodiment, when a backup event is detected while the user device is operating in the first encryption mode, data is encrypted using the first encryption key, and further the user device may transmit the encrypted data to the external device. In an embodiment, when a backup event is detected while the user device is operating in the second encryption mode, data (e.g., unencrypted data) may be transmitted to the external device to encrypt data using the second encryption key by the external device.

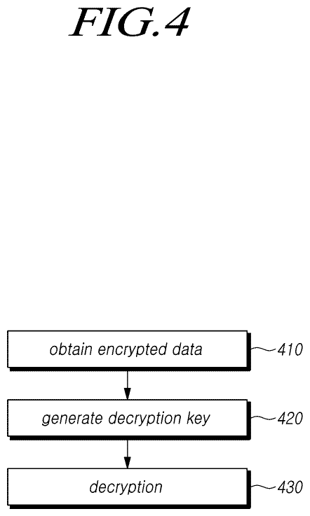

FIG. 4 is a flowchart illustrating an example method in which a user device decrypts data according to various embodiments.

Each operation of FIG. 4 may correspond to an instruction of the program stored in the memory (e.g., the memory 120 of FIG. 1) of the user device (e.g., the first device 100 of FIG. 1). The processor of the user device (e.g., the processor 110 of FIG. 1) may perform the following operation(s) by executing the instruction of the program.

In operation 410, the user device may obtain encrypted data from the server. The user device may request transmission of the encrypted data to the server based on a user input or preset scheduling information, and may receive the encrypted data in response to the request.

In operation 420, the user device may generate a decryption key. The user device may receive a first seed from the server and generate a second seed. The user device may generate a decryption key by performing predetermined (e.g., specified) operations on the first seed and the second seed. The predetermined operation may include, for example, at least some of simple listing, AND operation, OR operation, NOR operation, NAND operation, or XOR operation, but is not limited thereto.

In operation 430, the user device may decrypt the encrypted data using the decryption key. Decryption may be performed by a decryption operation such as e.g., Galois Field, but is not limited thereto.

In an embodiment, the user device may perform decryption in a manner at least partially different from the above-described decryption method, based on the encryption method. For example, as described above in operation 350 of FIG. 3, the encrypted data may be encrypted based on the first encryption key generated by the user device or may be encrypted based on the second encryption key generated by the server.

According to an embodiment, when the encrypted data is encrypted by a first encryption method, the user device may request a first seed for generation of the decryption key together with a request for transmission of the encrypted data. Then, the user device may decrypt the encrypted data using the first encryption key generated using the first and second seeds.

According to an embodiment, when encrypted data is encrypted by a second encryption method, the user device may request the server to transmit the encrypted data. The server may generate the decryption key using a seed that makes up a basis for generating the second encryption key. The encrypted data may be decrypted based on the generated decryption key. The decrypted data may be transmitted to the user device via the transceiver.

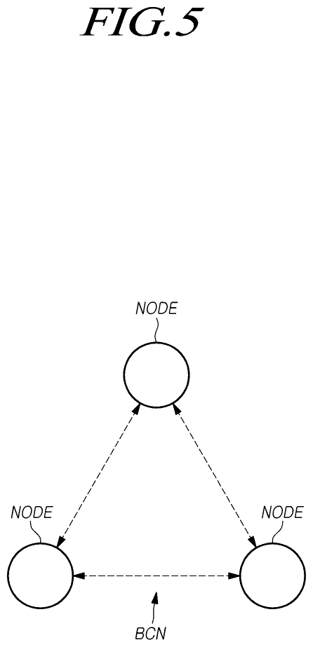

FIG. 5 is a diagram illustrating an example blockchain system according to various embodiments.

Blockchain is a computing technology designed to verify, store, and execute information and value across a network of all members, making it difficult for malicious forces to manipulate it arbitrarily.

The core technology of the blockchain may include a structure in which transaction records or information are stored individually without any help of a third party (Clearing House or Trusted Third Party (TTP), and the transaction is established only where the members are jointly authenticated. A blockchain is a set of connected blocks containing a multiplicity of transaction records and information, wherein each block is a chain structure that is organically linked to the previous block through a hash value, leading to the initial block (genesis block).

In such a case, a block refers to a type of data packet that is sequentially connected by encrypting the contents of information in the form of letters or numerals. Blocks containing new information are chained together at regular intervals, and by verifying validity in the process of connecting between the blocks, may prevent and/or reduce tampering with information inside the blockchain.

Types of blockchain may include public blockchain, private blockchain, consortium blockchain or the like.

The public blockchain is the first use case of blockchain that is generally open and operable to everyone over the Internet and may be notarized by anyone, possessing the property of mutual anonymity. The private blockchain is a personal blockchain that is accessible only to authorized users. A single entity may manage an internal network as a blockchain and provide platform services for development of that chain. The consortium blockchain is a semi-centralized blockchain that allows only a small number of pre-selected entities to participate therein. It has the property of participating in the notarization through the rules agreed between those entities and excellent network expandability. In the disclosure, the term “blockchain” may refer to the public blockchain, the private blockchain, or the consortium blockchain, altogether.

The core technology of the blockchain may include at least four underlying technologies such as peer-to-peer (P2P) network, encryption, distributed ledger, and distributed agreement. Each of these technologies is complementary to each other in their relationship in order to achieve decentralization, maintain data integrity, and so on. Hereinafter, core blockchain technology and blockchain technology combined with autonomous driving technology of a vehicle will be described.

A P2P network will be described. Communication and connectivity between participants in the blockchain may be performed based on the P2P network. The P2P network may refer, for example, to an autonomous configuration system including autonomous peers of equal qualifications for the purpose of sharing distributed resources without a centralized concept of service.

The P2P network is largely classified into a structured P2P and an unstructured P2P. The unstructured P2P may be further divided into ‘centralized P2P network’ in which a network is established between participants around a server, and ‘distributed P2P network’ based on a flooding algorithm of data. The blockchain may use a flooding-based unstructured P2P network to implement a decentralized distributed network.

Characteristics of the P2P network are as follows. In terms of distributed resource sharing, the target resource of interest is used in its distributed form and may be located at a network-end close to the peer. Each peer in the peer set uses the resources provided by the counterpart peer, and the target resources include audio/video data, applications, computing power, computing resources, and the like. The peers may be interconnected over a network and may be distributed across the globe. In terms of distributed autonomous organizations, each peer directly interacts between peers without separate centralized control or intervention to use shared resources. In terms of performance, there are some cases where it is necessary to introduce a centralization element into a P2P network of a fully distributed concept, which is referred to as a hybrid P2P network. To this end, a server may be used as a centralization element, and in particular, a mobile edge computing (MEC) server may play the role. Further, a hybrid P2P network may be configured with a specific peer as a centralization element. In such a P2P network, each peer provides flexibility in terms of functional availability by serving as both of the client and the server. Furthermore, each peer is equally qualified in terms of functional roles. Whether or not to share the resources held by each peer depends on the peer's autonomous decision.

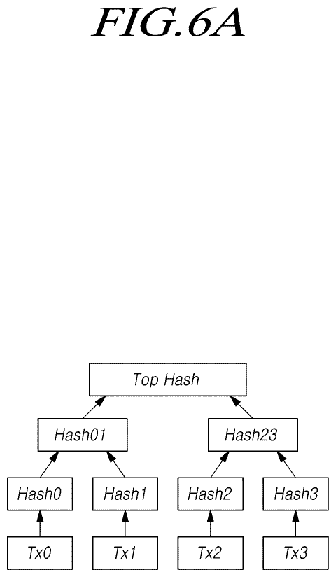

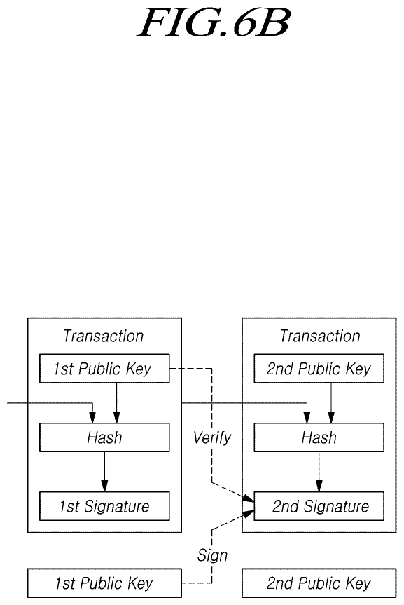

The encryption technology used in the blockchain may include, for example, and without limitation, a Merkle Tree technique and a public key-based digital signature technique. Each encryption technology will be described in greater detail below with reference to FIGS. 6A and 6B.

FIGS. 6A and 6B are diagrams illustrating an example of a blockchain encryption technology according to various embodiments.

FIG. 6A is a diagram illustrating a Merkle Tree scheme in a blockchain encryption technique. Referring to FIG. 6A, the Merkle Tree is a type of hash tree, and refers to a tree in which the names of all non-leaf nodes include a hash of child nodes. A leaf node refers to a file or data of a specific value, and a parent node is formed of a hash of such a leaf node. The root node of the Merkle Tree configured in this way may include a hash value of data of all nodes of the tree. In this case, the user may verify data tampering by simply verifying the root node's hash. Accordingly, the blockchain may configure the basis of the Merkle Tree by inserting transaction information between participants or the like into the leaf node. A function used in generating the Merkle Tree includes SHA-256, but various embodiments of the disclosure are not limited thereto.

FIG. 6B is a diagram illustrating a public key-based digital signature scheme in a blockchain encryption technology. Referring to FIG. 6B, the public key-based digital signature technique is an encryption technology that enables secure communication between the participants who have not shared a secret key in advance, and may be used in a technical field such as identity authentication. In the public key-based structure, there is a public key and a secret key, where the public key is known to all the participants and the secret key is known only to its owner. A user signs a transaction using his or her own secret key and then sends the transaction information to the blockchain network along with his or her own corresponding public key. Thereafter, other participants may then validate the transaction with the sender's public key.

The distributed ledger is a memory of information duplicated, shared, and synchronized by agreement between the participants. In order for the distributed ledger to be applied in the P2P network, the consent of the participants is required, and this is substantially the same in the blockchain. In the blockchain, the distributed ledger stores all the information generated after the participants' verification, and all the participants may maintain the same information. In the case of verifying information, connectivity with information recorded in the distributed ledger maintained by the individual participants is checked, and only legitimate information is stored in the distributed ledger of the blockchain through the participants' agreement.

Information is stored in block units accumulated over a certain period of time, and is stored in the distributed ledger with connectivity between blocks assigned. The distributed ledger is the basis for the integrity of data provided by the blockchain. The users participating in the blockchain main retain data from the same distributed ledger, and thus exert better security effects from external hacking or manipulation of certain users. For example, if external hackers attempt to tamper with certain data or make double transactions, then they must attempt to hack into the majority of the distributed ledgers owned by the participants, which will result in high costs and consumption of computing resources.

Distributed consensus is a protocol that derives consent for specific data between processes or agents in case where there is a process with combination in the fields such as distributed computing and multi-agent systems. Distributed consensus protocols include the properties of validity, integrity, agreement, and termination.

Consensus algorithms may use Proof of Work (PoW) algorithm, Proof of Stake (POS) algorithm, Deleted Proof of Stake (DPS) algorithm, Practical Byzantine Fault Tolerance (PBFT) algorithm, Proof of Elapsed Time (PoET) algorithm, Proof of Importance algorithm, and Proof of Authority (PoA) algorithm, and any other designed algorithms may also be used.

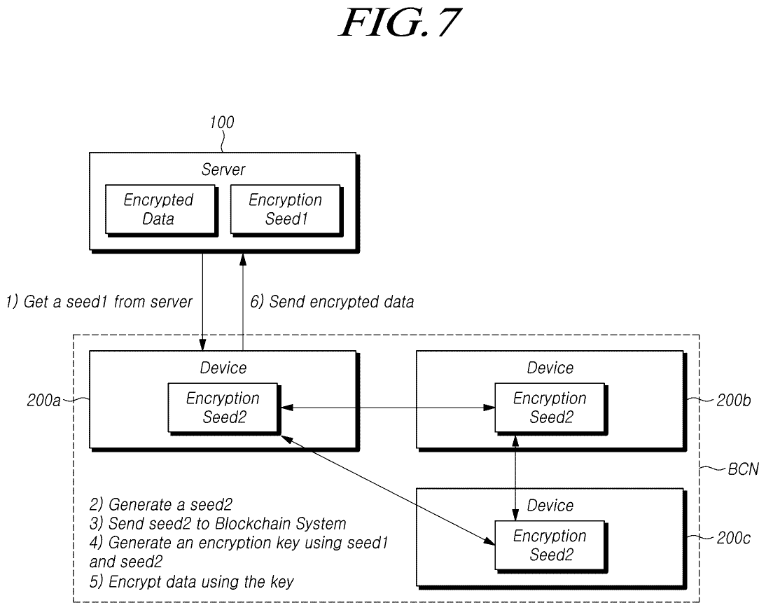

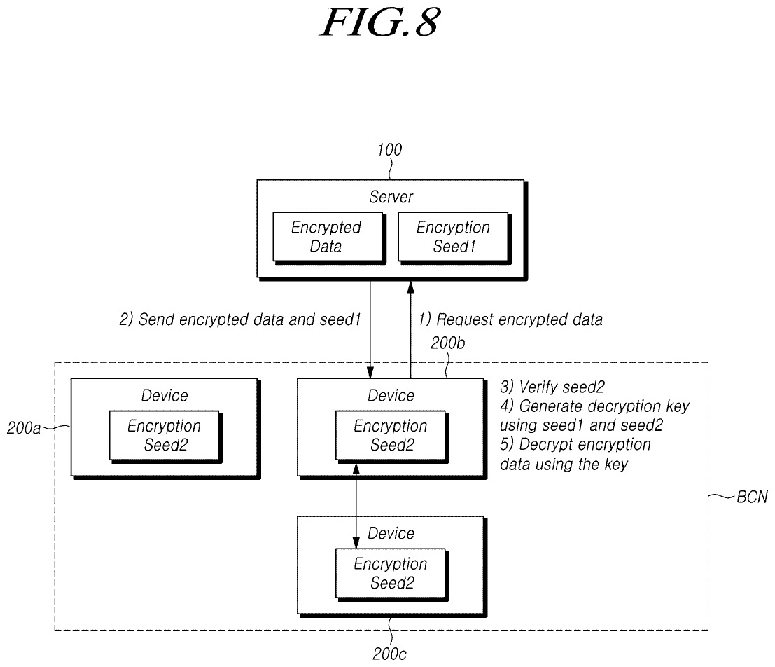

FIG. 7 is a diagram illustrating an example method for managing an encryption key using a blockchain system according to various embodiments, and FIG. 8 is a diagram illustrating an example method for decrypting encrypted data using a blockchain system according to various embodiments.

According to various embodiments of the disclosure, a blockchain technology may be used to share the second seed generated in the second device 200a (user device) through the blockchain system. In an embodiment of the disclosure, the second device 200a may generate an encryption key using both the first seed and the second seed and may encrypt data using the encryption key. The encrypted data may be decrypted only by the first encryption key generated by the first seed and the second seed. As a result, when the second device 200a is lost or damaged, the user cannot decrypt the data backed up in the first device 100. In the following embodiment, a method for sharing the second seed, which is generated or may be generated in the second device 200a to generate a decryption key through the blockchain network BCN, will be described as an example.

In an embodiment, the first device 100 (e.g., the server) may generate a first seed, and the second device 200a (e.g., the user device) may generate a second seed. In various embodiments of the disclosure, data may be encrypted by an encryption key generated using the first seed and the second seed, and the encrypted data may be decrypted by a decryption key generated using the first seed and the second seed.

In an embodiment, the second seed (e.g., the second seed that is a basis for encryption of encrypted data) may be provided to the blockchain network BCN, unlike the first seed. The blockchain network BCN may include a plurality of nodes. For example, the second seed may be provided from the second device 200a to the blockchain network BCN including the third device 200b and the fourth device 200c as nodes. Accordingly, the second seed may be provided to be distributed to a plurality of nodes of the blockchain network BCN.

In an embodiment, even if the user loses the second device 200a or the second device 200a is damaged, the second seed may exist on the third device 200b or the fourth device 200c. The third device 200b and the fourth device 200c may be any one of a plurality of nodes of the blockchain network BCN. The third device 200b and the fourth device 200c may store the second seed in the memory, and the second seed may be verified using the blockchain network BCN. As described above with reference to FIG. 6, the storage and verification of the second seed may be performed based on the distributed ledger and the distribution consensus. Hereinafter, description will be made on the premise that the decoding operation is performed by the third device 200b.

In an embodiment, the third device 200b may obtain encrypted data from the first device 100 and obtain the first seed for decrypting encrypted data from the first device 100 together or separately therefrom.

The third device 200b may have the validity of the second seed verified through another node (e.g., the fourth device 200c) of the blockchain network BCN. The third device 200b may generate a decryption key for decrypting the encrypted data using the verified second seed and the first seed obtained from the first device 100. Thereafter, the third device 200b may decrypt the encrypted data using the decryption key.

The device according to various embodiments disclosed in the disclosure may be one of various types of devices. The devices may include, for example, a display device, a portable communication device (e.g., a smartphone), a computer device, a portable multimedia device, a portable medical device, a camera, a wearable device, a home appliance, or the like. The devices according to an embodiment of the disclosure are not limited to those described above.

It should be appreciated that various embodiments of the disclosure and the terms used therein are not intended to limit the technological features described in the disclosure to particular embodiments, and include various changes, equivalents, or replacements of a corresponding embodiment. For example, a component expressed in the singular is to be understood as including a plurality of components unless the context clearly indicates only a singular meaning. As used in the disclosure, the term “and/or” is to be understood to encompass all possible combinations of one or more of the enumerated items. As used in the disclosure, the terms “comprise/include”, “have”, “consist of”, and the like are intended only to designate the presence of features, components, parts, or combinations thereof described in the disclosure, and the use of such terms is not intended to exclude the possibility of presence or addition of one or more other features, components, parts, or combinations thereof. As used herein, each of such phrases as “A or B”, “at least one of A and B”, “at least one of A or B”, “A, B, or C”, “at least one of A, B, and C”, and “at least one of A, B, or C” may include any one of, or all possible combinations of the items enumerated together in a corresponding one of the phrases. As used herein, such terms as “1st”, “2nd”, or “first” or “second” may be used to simply distinguish a corresponding component from another, and does not limit the components in other aspect (e.g., importance or order).

As used in connection with various embodiments of the disclosure, the term “˜ unit” or “˜ module” may include a unit implemented in hardware, software, or firmware, or any combination thereof, and may be interchangeably used with other terms, such as, for example, “logic”, “logic block”, “part”, or “circuit”. Such term “˜ unit” or “˜ module” may be a single integral component, or a minimum unit or a part of the component, adapted to perform one or more functions. For example, according to an embodiment, the term “˜ unit” or “˜ module” may be implemented in the form of an application-specific integrated circuit (ASIC).

As used in connection with various embodiments of the disclosure, the term “in case where (or that) ˜” may be understood as “when ˜”, “if ˜”, “in response to determining ˜”, or “in response to detecting ˜”, depending on the context. Similarly, the phrases “when it is determined that ˜” or “when it is detected that ˜” may be understood as “when determining ˜”, “in response to determining ˜”, “when detecting ˜” or “in response to detecting ˜”, depending on the context.

The program executed by the first device 100 and/or the second device 200 described in the disclosure may be implemented as a hardware component, a software component, and/or a combination of the hardware component and the software component. The program may be performed by any system capable of executing computer-readable instructions.

Software may include a computer program, a code, an instruction, or a combination of one or more of them, and may configure a processing unit to operate as desired or instruct the processing unit independently or collectively. The software may be implemented as a computer program including instructions stored in a computer-readable storage medium. The computer-readable storage media may include, for example, magnetic storage media (e.g., read-only memory (ROM), random-access memory (RAM), a floppy disk, hard disk, etc.), optical readable media (e.g., compact disc read only memory (CD-ROM), digital versatile disc (DVD)) and the like. The computer-readable storage media may be distributed over networked computer systems, so that computer-readable codes may be stored and executed in a distributed manner. The computer program product may be distributed (e.g., downloaded or uploaded) directly or online through an application store (e.g., PlayStore™) or between two user devices (e.g., smartphones). If distributed online, at least part of the computer program product may be at least temporarily stored or generated in a machine-readable storage medium, such as memories of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more components or operations of the above-described components may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for encrypting data by a user device, comprising:
obtaining a first seed from an external device;
generating a second seed in response to obtaining the first seed;
generating a first encryption key based on the first seed and the second seed; and
encrypting data using the first encryption key.

2. The method of claim 1, wherein obtaining the first seed from the external device comprises:
requesting transmission of the first seed to the external device; and
receiving the first seed from the external device in response to the request.

3. The method of claim 2, wherein requesting the transmission of the first seed is triggered based on detecting a backup event.

4. The method of claim 3, wherein the backup event is detected based on receiving an input requesting data backup or specified reservation information.

5. The method of claim 3, wherein the encrypting is performed in one of:
a first encryption mode configured to encrypt the data using a first encryption key, or
a second encryption mode configured to encrypt the data using a second encryption key different from the first encryption key.

6. The method of claim 5, further comprising:
in response to detection of the backup event in the first encryption mode, encrypting the data using the first encryption key; and
transmitting the encrypted data to the external device.

7. The method of claim 5, further comprising:
in response to detection of the backup event in the second encryption mode, transmitting the data to the external device so that the external device encrypts the data using the second encryption key.

8. The method of claim 1, wherein the first seed and the second seed comprise a random number of at least 16 bytes or at least 32 bytes.

9. The method of claim 1, further comprising transmitting the encrypted data to the external device.

10. The method of claim 1, further comprising providing the second seed to a blockchain network including a plurality of nodes.

11. A user device comprising:
at least one processor, comprising processing circuitry;
memory; and
one or more programs, the one or more programs stored in the memory and configured to be executed by the one or more processors,
wherein the one or more programs comprises instructions, and at least one processor, individually and/or collectively, is configured to execute the instructions, and to cause the user device to perform:
obtaining a first seed from an external device;
generating a second seed in response to obtaining the first seed;
generating a first encryption key based on the first seed and the second seed; and
encrypting data using the first encryption key.

12. The user device of claim 11, wherein obtaining the first seed from the external device comprises:
requesting transmission of the first seed to the external device; and
receiving the first seed from the external device in response to the request.

13. The user device of claim 12, wherein requesting the transmission of the first seed is triggered based on detecting a backup event.

14. The user device of claim 13, wherein the backup event is detected based on receiving an input requesting data backup or specified reservation information.

15. The user device of claim 13, wherein the encrypting is performed in one of:
a first encryption mode configured to encrypt data using a first encryption key, or
a second encryption mode configured to encrypt data using a second encryption key different from the first encryption key.

16. The user device of claim 15, wherein at least one processor, individually and/or collectively, is configured to cause the user device to perform:
based on the backup event being detected in the first encryption mode, encrypting the data using the first encryption key, and transmitting the encrypted data to the external device.

17. The user device of claim 15, wherein at least one processor, individually and/or collectively, is configured to cause the user device to perform, based on the backup event being detected in the second encryption mode, transmitting the data to the external device so that the external device encrypts the data using the second encryption key.

18. The user device of claim 11, wherein the first seed and the second seed comprise a random number of at least 16 bytes or at least 32 bytes.

19. The user device of claim 11, wherein at least one processor, individually and/or collectively, is configured to cause the user device to transmit the encrypted data to the external device.

20. The user device of claim 11, wherein at least one processor, individually and/or collectively, is configured to cause the user device to provide the second seed to a blockchain network including a plurality of nodes.
